(19) United States
(12) Patent Application Publication
(10) Pub. No.: US 2025/0002733 A1
(43) Pub. Date: Jan. 2, 2025

(54) AQUEOUS STABILIZER COMPOSITION AND ITS USE

(71) Applicant: Ewald Dörken AG, Herdecke (DE)

(72) Inventors: Marcel Roth, Düsseldorf (DE); Daniel Miri, Wuppertal (DE); Jan Lischeid, Wetter (DE); Gerhard Reusmann, Wetter (DE)

(73) Assignee: Ewald Dörken AG, Herdecke (DE)

(21) Appl. No.: 18/749,126

(22) Filed: Jun. 20, 2024

(30) Foreign Application Priority Data
Jun. 27, 2023 (EP) 23181631.5

(51) Int. Cl. C09D 7/43; C09D 7/61; C09D 7/65; C09D 133/02; C09D 137/00

(52) U.S. Cl. CPC C09D 7/43; C09D 7/61; C09D 7/65; C09D 133/02; C09D 137/00

(57) ABSTRACT

An aqueous composition for stabilizing dispersions, which includes a compound having a solubility in water in the range from 0.05 to 10 g/l at 20° C., and its use.

### CROSS REFERENCE TO RELATED APPLICATION

This application claims the benefit of European Patent Application No. EP23181631.5, filed Jun. 27, 2023, which is incorporated herein by reference in its entirety.

### FIELD

The present invention relates to the technical field of coatings, in particular semi-finished products and pigment pastes for coatings.

### BACKGROUND

In particular, the present invention relates to an aqueous composition for stabilizing dispersions.

Furthermore, the present invention relates to the use of said aqueous composition for stabilizing dispersions and to the corresponding stabilized dispersions, in particular semi-finished products.

Finally, the present invention relates to a method for producing aqueous compositions for stabilizing dispersions.

### BRIEF DESCRIPTION OF THE DRAWINGS

The figures show according to FIG. 1: the sedimentation profile of a commercially available calcium aluminate sulfate suspension;

FIG. 2: the stability index of a commercially available calcium aluminate sulfate suspension at t=500 s;

FIG. 3: the stability indices of a commercially available calcium aluminate sulfate suspension compared to calcium aluminate sulfate suspensions stabilized according to the invention at t=500 s;

FIG. 4: the stability indices of a commercially available calcium aluminate sulfate suspension in comparison to calcium aluminate sulfate suspensions stabilized according to the invention as a function of time;

FIG. 5: the stability indices of a commercially available calcium aluminate sulfate suspension, a calcium aluminate sulfate suspension stabilized according to the invention and of comparative suspensions which, in addition to calcium aluminate, comprise only one thickener, at the time t=500 s;

FIG. 6: the stability indices of a commercially available calcium silicate hydrate suspension compared to a calcium silicate hydrate suspension stabilized according to the invention at t=500 s; and

FIG. 7: the stability indices of a commercially available calcium silicate hydrate suspension compared to a calcium silicate hydrate suspension stabilized according to the invention as a function of time.

### DETAILED DESCRIPTION

Modern coating systems, in particular paints, are increasingly being formulated on a water-based basis, as they should be free of volatile organic compounds (VOCs) wherever possible. Such VOC-free paint systems, or systems with a VOC content of less than 1 g/l, are considered to be solvent-free and emission-free. From the point of view of environmental and health protection, they are not, or at least less, problematic than solvent-based systems.

In addition, efforts are being made to avoid the use of preservatives and biocides in paints, or at least to reduce their use. If the paint systems do not contain any preservatives or biocides, then as a rule no hazardous substances need to be declared and the paints can be used and processed without any problems in terms of occupational safety and without any special safety precautions.

In practice, the use of aqueous systems, in particular in combination with organic binder systems, regularly leads to a rapid infestation of the coating with germs, in particular with bacteria, yeasts or even mold, so that preservatives and/or biocides usually have to be added to the coatings. This applies in particular to aqueous pigment pastes, which are used in particular for tinting systems. Tinting systems are generally used to provide a wide range of different colors and color shades that can be individually selected and combined by customers. Tinting systems usually consist of a palette of colored pigment pastes that are mixed with a binding agent or a mixture of binding agents, the so-called tinting base or base composition, in order to obtain paints, in particular wall paints, with a desired hue. The pigment pastes are highly concentrated pigment-containing dispersions. The pigment paste and the base or tinting base are then mixed together to produce the ready-to-use color or coating.

The mixing of individual pigment pastes in varying amounts with the tinting base is carried out in machines in which the mixing process is carried out with the support of software. The pigment pastes are stored in a more or less open state for several weeks after they have been removed from the original container, and during this time they are exposed to germs, in particular bacteria, yeasts and mold spores, via the ambient air, which almost inevitably leads to an infestation with bacteria, yeasts or mold in the case of solvent-free or water-based systems.

For this reason, preservatives and biocides are used almost exclusively in water-based pigment pastes and tinting systems. However, the use of biocides and preservatives is disadvantageous for a variety of reasons, as biocides and preservatives generally represent problematic substances for both health and environmental protection, whose use should be minimized and whose use is increasingly being regulated by stricter chemicals legislation. Furthermore, a serious disadvantage of conventional organic biocides is their vapor pressure: the biocides transition into the gas phase and can, for example, trigger allergies, wherein in particular the danger of an accumulation of the biocides in the air of interior rooms exists.

Furthermore, organic biocides are usually not long-term stable and are, for example, decomposed by UV radiation.

There are therefore attempts to provide aqueous pigment pastes, in particular for tinting systems, without preservatives or biocides. To do this, the pH of the pigment paste is usually set to a value of 10 or higher, creating an environment in which many bacteria and yeasts, as well as the majority of fungi, cannot grow.

However, it has been shown that a large number of alkaliphilic bacteria, yeasts and fungi, in particular molds, exist that either grow well under these alkaline conditions or can successfully adapt to these conditions. In order to combat these alkaliphilic germs, preservatives and biocides must be used.

Furthermore, it is also known that calcium aluminate sulfate, which comprises the mineral ettringite with the empirical formula Ca₆Al₂[(OH)₁₂(SO₄)₃]·26H₂O, is used as a white pigment in paints and paper coatings. Calcium aluminate sulfate is sold in the form of an aqueous basic suspension and can be added in small amounts, in particular to paints. A method for producing precipitates based on calcium aluminate sulfate is described in WO 97/35807 A1. It is not possible to use large amounts of calcium aluminate sulfate in binder systems, as the relatively good solubility in water and the resulting amounts of divalent and trivalent ions in the dispersion cause binder systems to thicken rapidly. In particular, coagulation of dispersed constituents, in particular electrostatically stabilized constituents, is observed. However, the divalent and trivalent ions present in the solution, in particular aluminum ions, also cause the aqueous suspensions of calcium aluminate sulfate to comprise a germ-resistant effect that goes beyond the basic pH value, i.e. the aqueous suspensions of calcium aluminate sulfate are difficult to infest or colonize by germs of all kinds, in particular bacteria, yeasts or molds.

However, calcium aluminate sulfate has the further disadvantage of being less dispersion-stable and drying out quickly when processed into paints, i.e. the open time of the paints is very short.

EP 4 183 842 A1 describes a composition, in particular a pigment paste, in which calcium aluminate sulfate can be dispersed in amounts of up to 20 wt. % in a manner that is stable over the long term. These pigment preparations are also excellently suited for incorporation into coating systems, in particular paints and varnishes, which, through the use of the pigment paste, are permanently protected against contamination with microorganisms even without the use of biocides.

However, the use of calcium aluminate sulphate, in particular ettringite, and other compounds with a solubility of approx. 1 g/l is problematic because substances with such residual solubilities are subject to so-called Ostwald ripening. On the one hand, this means that large crystals or particles grow at the expense of smaller crystals or particles, which means that even stabilized dispersions become unstable during storage; larger crystals form that tend to sediment more heavily. Furthermore, touching crystals grow together at the interfaces, so that the sediment hardens and can no longer be redispersed even by conventional mechanical methods, such as stirring, in particular not with defined particle sizes. These properties are particularly problematic for use in pigment pastes or paints, since defined amounts of particles with defined particle sizes must be present in a dispersion to achieve a uniform color appearance and uniform color properties. While pigment pastes or paints that contain calcium aluminate sulfate or similar substances with a relatively high residual solubility can be stabilized for long periods of time because they comprise a relatively small proportion of these problematic compounds, this has been difficult to achieve with preliminary products, in particular semi-finished products used for producing pigment pastes or coating systems, has so far been difficult, as these products comprise high quantities of calcium aluminate sulfate or similar substances. In particular, calcium aluminate sulfate dispersions tend to settle out and must be continuously stirred to prevent the formation of a hard sediment.

The strong tendency to settle also causes problems in ongoing production, as a crust forms in the lower part of the supply lines and the lines become blocked as a result of further crystal growth and the accumulation of particles.

Pre-products, in particular semi-finished products, which contain calcium aluminate sulfate, must be continuously stirred or at least regularly discharged. Delivery to the production site must be carried out close to the production site, involving high expenditure in logistics and storage, since the quality of the dispersion rapidly deteriorates if stored without stirring: sedimentation and the production of an irreversible deposit quickly occur. This applies to all production applications of aqueous formulations of calcium aluminate sulfate and, in general, of compounds with relatively high residual solubility that are present in a water-based suspension.

This problematic behavior also prevents the use of calcium aluminate sulfate or similar compounds, such as calcium silicate hydrate, in other technical areas, in particular in cosmetic formulations, disinfectants or pharmaceutical formulations, for which they would in principle be suitable as pigments, carriers, etc.

Dispersions of solids in liquids can usually be stabilized using wetting or dispersing agents. However, this type of stabilization is only possible to a limited extent for compounds with a high residual solubility, as there is a dynamic equilibrium between the particle surfaces and the dissolved ions. Conventional wetting agents cannot or can only have a limited effect, as the particle interfaces are not thermodynamically stable. In particular, electrostatic stabilization is not possible or only possible to a very limited extent due to these dynamic processes.

It is known that thickeners can delay the production of solid sediments by slowing down the sedimentation and diffusion of ions, but they cannot stop the process.

In addition, the use of thickeners has the disadvantage that the thickened solutions are difficult to process due to their high viscosity, and low-viscosity dispersions are used in production processes wherever possible, especially if the dispersions are transported using pumps. In addition, the high increase in viscosity also leads to severely limited product applications, since low viscosities are desired or required for many applications, for example in paints and varnishes. In particular, many thickeners lead to a strong thickening of the dispersion using gel formation, which makes the dispersion unsuitable for many applications. Furthermore, the presence of divalent and trivalent metal ions, which often occur in high concentrations in dispersions of compounds with high residual solubility, often leads to rapid gel formation in combination with thickeners, which in turn makes the products unsuitable for a wide range of applications.

The state of the art thus still lacks a composition or a method that enables the stabilization of dispersions of compounds with a solubility in water of approx. 1 g/l to 10 g/ at 20° C. 1.

In particular, it is not known in the prior art how highly filled dispersions comprising a high proportion of a compound with a high residual solubility can be permanently stabilized without a solid sediment forming.

One object of the present invention is thus to provide a system that avoids, or at least mitigates, the aforementioned disadvantages and problems associated with the state of the art.

In particular, one object of the present invention is to provide a system that enables the long-term stable dispersion of compounds with a high residual solubility in high concentrations.

A further object of the present invention is to provide a system which enables the stabilization of dispersions containing compounds with high residual solubilities in high concentrations, wherein the dispersion maintains a low viscosity.

A further object of the present invention is to provide a low-viscosity, long-term stable dispersion of a compound with a high residual solubility.

The subject-matter of the present invention—according to a first aspect of the present invention—is thus an aqueous composition according to claim 1; further advantageous embodiments of this aspect of the invention are the subject-matter of the respective dependent claims.

A further subject-matter of the present invention—according to a second aspect of the present invention—is the use of an aforementioned aqueous composition according to claim 15.

A further subject-matter of the present invention—according to a third aspect of the present invention—is an aqueous dispersion according to claim 16.

A further subject-matter of the present invention—according to a fourth aspect of the present invention—is a method according to claim 17.

It goes without saying that special features, characteristics, configurations and embodiments, as well as advantages or the like, which are described below—for the purpose of avoiding unnecessary repetition—only in relation to one aspect of the invention, naturally apply accordingly in relation to the other aspects of the invention, without the need for express mention.

In addition, it should be noted that, in the case of all the relative or percentage, in particular weight-related, quantities given below, these are to be selected by the skilled person in such a way that the sum of the ingredients, additives or auxiliary substances or the like always results in 100% or 100 wt. %. However, this is self-evident for the skilled person.

Furthermore, all the parameter values or the like mentioned below can be measured or determined using standardized or explicitly stated methods of determination or using methods of determination that are familiar to the skilled person.

With this proviso, the subject-matter of the present invention is explained in more detail below.

The subject-matter of the present invention—in accordance with a first aspect of the present invention—is thus an aqueous composition, in particular a solution or dispersion, for stabilizing dispersions which comprise a compound having a solubility in water in the range from 0.05 to 10 g/l at 20° C., wherein the composition comprises
(a) at least one thickener, and
(b) at least one wetting or dispersing agent.

Preferably, the aqueous composition, in particular solution or dispersion for stabilizing dispersions, which comprise a compound having a solubility in the range from 0.05 to 10 g/l at 20° C. in water, consists of at least one thickener, at least one wetting or dispersing agent and water.

Through the use of a solution or dispersion which contains a thickener and a wetting or dispersing agent, it is possible to disperse dispersions of compounds with a high residual solubility, in particular with solubilities in the range from 0.05 to 10 g/l at 20° C. in water, with long-term stability. Surprisingly, this can also be achieved if the dispersion contains the compound with the high residual solubility in high proportions, such as 70 or 80 wt. %, based on the dispersion.

Furthermore, a stabilized low-viscosity dispersion of compounds with a high residual solubility can be obtained by the combination of thickener and wetting or dispersing agent according to the invention, whereby the dispersion can be industrially processed and supplied to a variety of applications.

In the context of the present invention, a solution is to be understood as a usually liquid single-phase system in which at least one substance, in particular a compound or its building blocks, such as ions, is present homogeneously distributed in another substance, the so-called solvent. In the context of the present invention, a dispersion is to be understood as an at least two-phase system, wherein a first phase, namely the dispersed phase, is present distributed in a second phase, the continuous phase. The continuous phase is also referred to as a dispersion medium or dispersant; the continuous phase in the context of the present invention is usually in the form of a liquid, and dispersions in the context of the present invention are therefore generally solid-in-liquid dispersions. The compound having a solubility in the range of 0.05 to 10 g/l at 20° C. in water is usually the dispersed phase or one of the dispersed phases within the scope of the present invention.

Surprisingly, the approach according to the invention also makes it possible to suppress Ostwald ripening, so that once a particle size has been set, it is also present in the dispersion with long-term stability, in particular for months, and moreover no solid and non-redispersible sediment forms in the storage containers. Gel formation, which is usually observed when thickeners are used alone, can also be effectively avoided in the context of the present invention, whereby the viscosities of the dispersion can be kept within an acceptable range for many applications. This is surprising, in particular, since high concentrations of divalent and trivalent metal ions often contribute to gel formation in the presence of thickeners.

The composition according to the invention is suitable in particular for stabilizing dispersions in the technical fields of pastes, colors, varnishes, glazes, paper production, cosmetic formulations, pharmaceutical formulations, liquid semi-finished products and raw materials for industrial processes, detergents and cleaning agents, impregnating and disinfecting agents and surface finishing.

Particularly good results are obtained in the context of the present invention if the dispersion to be stabilized comprises a compound with a solubility in water of less than 10 g/l, in particular less than 4 g/l, preferably less than 3 g/l, more preferably less than 2 g/l, particularly preferably less than 1.5 g/l, even more preferably less than 1 g/l, at 20° C.

Similarly, particularly good results are obtained if the dispersion to be stabilized comprises a compound with a solubility in water of more than 0.1 g/l, in particular more than 0.2 g/l, preferably more than 0.3 g/l, more preferably more than 0.4 g/l, at 20° C.

Furthermore, it has been well proven in the context of the present invention if the dispersion to be stabilized comprises a compound with a solubility in the range from 0.05 to 5 g/l, in particular 0.1 to 4 g/l, preferably 0.2 to 3 g/l, more preferably 0.2 to 2 g/l, particularly preferably 0.3 to 1.5 g/l, even more preferably 0.4 to 1 g/l, at 20° C. in water.

Compounds with the aforementioned relatively high solubilities, also known as residual solubilities, are in principle poorly soluble and can be provided in the form of aqueous dispersions. However, due to the noticeable and not inconsiderable solubility and the associated high concentration of ions in the liquid phase, these dispersions cause a number of problems during production and use. One of the main problems is the aforementioned Ostwald ripening, which results from the fact that the compounds are subject to dynamic dissolution and deposition processes, whereby the particle size shifts towards larger particles, which in turn causes a greater tendency to sedimentation and also changes the properties of the dispersions and the pigment pastes and colors comprising them. In addition, these dynamic processes also lead to agglomerate formation and ultimately to the production of a compact sediment, which can no longer be redispersed even using conventional mechanical means.

In addition, the presence of metal ions, in particular divalent and trivalent metal ions in high concentrations often also leads to gel formation by reaction with binder systems or rheology additives, in particular thickeners. In the context of the present invention, however, these negative effects can be avoided.

In the context of the present invention, the compound having a solubility in the range of 0.05 to 10 g/l at 20° C. in water is usually selected from the group of magnesium aluminum phosphates, magnesium aluminum silicates, calcium aluminum phosphates, calcium aluminum silicates, calcium aluminate hydrates, calcium aluminate sulfate, calcium sulfate, calcium hydroxide, calcium silicate hydrate, ammonium trifluoromanganate (NH₄MnF₃), sodium trifluoromanganate (NaMnF₃), manganese(II) fluoride, sodium fluoride and mixtures thereof.

Particularly good results are obtained in the context of the present invention if the compound with a solubility in water in the range from 0.05 to 10 g/l at 20° C. is selected from calcium aluminate hydrates, calcium aluminate sulfate, calcium sulfate, calcium hydroxide, calcium silicate hydrate, ammonium trifluoromanganate (NH₄MnF₃), sodium trifluoromanganate (NaMnF₃), manganese(II) fluoride, sodium fluoride and mixtures thereof.

Particularly good results are obtained in this context if the compound with a solubility in water in the range from 0.05 to 10 g/l at 20° C. is selected from the group of tricalcium aluminate hydrate [3 CaO*Al₂O₃*6 H₂O resp. Ca₃Al₂(OH)₁₂], tetracalcium aluminate hydrate [4 CaO*Al₂O₃*7 H₂O resp. Ca₄Al₂(OH)₁₄], calcium aluminate sulphate [ettringite, 3 CaO*Al₂O₃*3 CaSO₄*32 H₂O resp. Ca₆[Al(OH)₆]2(SO₄)₂*26 H₂O], calcium sulphate, calcium hydroxide, calcium silicate hydrate [Ca₆Si₆Oi₁₈*H₂O], ammonium trifluoromanganate (NH₄MnF₃), sodium trifluoromanganate (NaMnF₃), manganese(II) fluoride, sodium fluoride and mixtures thereof. Especially good results are obtained in this context if the compound with a solubility in the range from 0.05 to 10 g/l at 20° C. in water is selected from tetracalcium aluminate hydrate, calcium aluminate sulfate, calcium silicate hydrate and mixtures thereof, preferably calcium aluminate sulfate, calcium silicate hydrate and mixtures thereof.

In the context of the present invention, it is particularly preferred if the compound with a solubility in the range from 0.05 to 5 g/l at 20° C. in water is calcium aluminum sulfate [ettringite, 3 CaO*Al₂O₃*3 CaSO₄*32 H₂O resp. Ca₆[Al(OH)₆]2(SO₄)₂*26 H₂O]. The molecular formula is sometimes given as 24 molecules of water of crystallization, which differs from the notation of 26 molecules of water of crystallization shown above. However, the same compound is always meant.

Calcium aluminum sulfate is sold commercially in the form of aqueous suspensions. Calcium aluminate sulphate is composed of the mineral ettringite and contains a calcium oxide content of approx. 13.5 wt. %, an aluminum oxide content of approx. 8 wt. % and a water of crystallization content of approx. 45 wt. %. Calcium aluminum sulfate or ettringite or its aqueous dispersion is also occasionally used as a white pigment in architectural paints and in paper coatings. Calcium aluminum sulfate comprises a high covering power as well as a strong settling and rapid drying behavior, so that it usually cannot be used in high concentrations in aqueous dispersions, in particular in paints, and the processing into coatings is already problematic.

It is common in the context of the present invention for the compound with a solubility in the range of 0.05 to 10 g/l in water at 20° C. to be present in particulate form.

In the context of the present invention, according to one embodiment, it may be provided that the compound with a solubility in the range from 0.05 to 10 g/l at 20° C. in water comprises a particle size distribution D10 in the range from 0.05 to 0.5 μm, in particular 0.1 to 0.4 μm, preferably 0.15 to 0.3 μm, more preferably 0.18 to 0.25 μm.

Similarly, it may be envisaged that the compound with a solubility in the range from 0.05 to 5 g/l at 20° C. in water comprises a particle size distribution D50 in the range from 1.0 to 4 μm, in particular 1.5 to 3.0 μm, preferably 1.8 to 2.7 μm, more preferably 2.0 to 2.5 μm.

It may also be provided that the compound with a solubility in the range from 0.05 to 10 g/l at 20° C. in water comprises a particle size distribution D90 in the range from 5.0 to 10 μm, in particular 5.5 to 8.0 μm, preferably 6.0 to 7.5 μm, more preferably 6.5 to 7.0 μm.

The terms D10, D50 and D90 each mean that 10% of all particles have a smaller particle size or 50% of all particles or 90% of all particles. The particle sizes or the particle size distribution can be determined in particular by laser scattering.

According to a particularly preferred embodiment of the present invention, the compound with a solubility in the range from 0.05 to 10 g/l at 20° C. in water comprises a particle size distribution D10 in the range from 0.05 to 0.45 μm, in particular 0.1 to 0.4 μm, preferably 0.15 to 0.3 μm, more preferably 0.18 to 0.25 μm.

Similarly, according to this embodiment, it may be provided that the compound with a solubility in the range from 0.05 to 10 g/l at 20° C. in water comprises a particle size distribution D50 in the range from 0.5 to 1.8 μm, in particular 0.6 to 1.5 μm, preferably 0.7 to 1.2 μm, more preferably 0.8 to 1.0 μm.

Furthermore, according to this embodiment, it may be provided that the compound with a solubility in the range from 0.05 to 10 g/l at 20° C. in water comprises a particle size distribution D90 in the range from 2.0 to 4 μm, in particular 2.2 to 3.7 μm, preferably 2.5 to 3.5 μm, more preferably 2.8 to 3.2 μm.

Particles with the aforementioned particle sizes are particularly suitable for use in pigment pastes and paints, but also in paper production, cosmetic formulations, pharmaceutical formulations, liquid semi-finished products and raw materials for industrial processes, detergents and cleaning agents, impregnating and disinfecting agents and surface finishes.

As far as the thickener is concerned, this can be selected from a large number of possible compounds within the scope of the present invention.

However, particularly good results are obtained in the context of the present invention if the thickener is selected from the group of polysaccharides, proteins, polyvinyl alcohols, silicic acids, silicates and mixtures thereof. It is particularly preferred in the context of the present invention if the thickener is a polysaccharide.

According to a preferred embodiment of the present invention, the thickener is selected from the group consisting of xanthan gum, beta-glucans, thiolated polysaccharides, proteoglycans, gum arabic, karaya, tragacanth, locust bean gum, guar, quince mucilage, pectin, agar-agar, carrageenan, alginates, starches, starch derivatives, cellulose, cellulose derivatives, in particular cellulose ethers, silicic acids, bentonites, phyllosilicates, polyvinyl alcohols, gelatine, casein and mixtures thereof. Particularly good results are obtained in this context if the thickener is selected from the group of xanthan gum, beta-glucans, thiolated polysaccharides, proteoglycans, cellulose ethers, silicic acids, bentonites, phyllosilicates, polyvinyl alcohols, gelatine, casein and mixtures thereof. Best results are obtained within the scope of the present invention if the thickener is a cellulose ether.

If the thickener is a cellulose ether, it is specially well proven if the thickener is selected from the group of carboxymethylcellulose (CMC), methylcellulose (MC), ethylcellulose (EC), hydroxyethyl cellulose (HEC), hydroxypropyl cellulose (HPC), methyl ethyl cellulose (MEC), hydroxyethyl methyl cellulose (HEMC), hydroxypropyl methyl cellulose (HPMC), ethyl hydroxyethyl cellulose and mixtures thereof.

As far as the wetting or dispersing agent in the aqueous composition according to the invention is concerned, this is usually selected from the group of non-ionic polymers, cationic polymers, anionic polymers and mixtures thereof, in particular non-ionic polymers, anionic polymers, copolymers with pigment affinity groups, polyethers and mixtures thereof. A large number of surface-active substances can therefore be used as wetting or dispersing agents. Wetting or dispersing agents with pigment-affine groups are particularly preferred.

Particularly good results are obtained in the context of the present invention if the wetting or dispersing agent is selected from the group of polymers with pigment-affinity groups, silicone-modified polymers, block copolymers, graft copolymers, surfactants, modified natural oils and mixtures thereof.

Furthermore, it is well proven in the context of the present invention if the wetting or dispersing agent is selected from the group of polycarboxylates, in particular salts of polyacrylic acids, polyphosphates, in particular linear polyphosphates and/or cyclic metaphosphates, polyether phosphates, polycarboxylic acid polymers, acrylic block copolymers, polyurethanes, ethoxylated fatty alcohols, non-ionic saturated long-chain alcohols, fatty alcohol sulphates, alkyl phosphonates, polysiloxane ethers, in particular methoxypolyethoxypropyl trisiloxanes, alkynyl ethoxylates, surfactants, gemini surfactants, bola surfactants, fluorosurfactants, modified natural oils and mixtures thereof.

Furthermore, it is well proven if the wetting or dispersing agent is selected from the group of salts of polyacrylic acids, polyphosphates, in particular linear polyphosphates and/or cyclic metaphosphates, polyether phosphates, polycarboxylic acid polymers, acrylic block copolymers, polyurethanes ethoxylated fatty alcohols, non-ionic saturated long-chain alcohols, fatty alcohol sulphates, alkyl phosphonates, polysiloxane ethers, in particular methoxypolyethoxypropyl trisiloxanes, alkynyl ethoxylates, gemini surfactants, bola surfactants, modified natural oils and mixtures thereof.

According to a preferred embodiment of the present invention, it is provided that the wetting or dispersing agent is selected from the group consisting of sodium salts of polyacrylic acids, ammonium salts of polyacrylic acids, polyether phosphates, polycarboxylic acid polymers, modified styrene-maleic acid copolymers, polysiloxane ethers, in particular methoxypolyethoxypropyltrisiloxanes, gemini surfactants, bola surfactants, modified natural oils and mixtures thereof.

Best results are obtained within the scope of the present invention if the wetting or dispersing agent is a modified styrene-maleic acid copolymer.

Preferably, the polymers of the aforementioned wetting or dispersing agents are functionalized, in particular acidic and/or basic functionalized. Preferably, the polymer comprises at least one functional group which can be selected in particular from the group of hydroxyl (—OH), thiol (—SH), amine, ammonium, carboxyl, carbonyl, ester, ether, sulfonyl, phosphonic acid, phosphoric acid and/or phosphoric acid ester functions, preferably hydroxyl (—OH), thiol (—SH) and/or amine functions.

The molecular weight of the wetting or dispersing agent used can also vary over a wide range. Typically, the wetting or dispersing agent used comprises an average, in particular weight-average molecular weight of at least 1,000 g/mol, preferably at least 1,500 g/mol. In general, the wetting or dispersing agent comprises an average, in particular weight-average molecular weight in the range from 1,000 to 1,000,000 g/mol, in particular 1,250 to 100,000 g/mol, preferably 1,500 to 75,000 g/mol, particularly preferred 2,000 to 50,000 g/mol.

Advantageously, the wetting or dispersing agent is based on a functionalized, in particular acidic and/or basic functionalized, polymer, in particular with polar functional groups. For example, the wetting or dispersing agent can be selected from the group of functionalized polyamines, functionalized polyurethanes, functionalized poly(meth)acrylates, functionalized vinyl copolymers, functionalized polyether/polyester copolymers, functionalized polyethers, functionalized polyesters, functionalized fatty acid copolymers, functionalized block copolymers and/or functionalized polyalkoxylates as well as mixtures or combinations of at least two of these compounds.

The polymers of the aforementioned wetting or dispersing agents are preferably acidic and/or basic functionalized, Preferably, the polymer comprises at least one functional group, which can be selected in particular from the group of hydroxyl (—OH), thiol (—SH), amine, ammonium, carboxyl, carbonyl, ester, ether, sulfonyl, phosphonic acid, phosphoric acid and/or phosphoric acid ester functions, preferably hydroxyl (—OH), thiol (—SH) and/or amine functions.

Preferably, the wetting or dispersing agent may be selected from the following dispersing and/or wetting agents as described in the following publications, the respective disclosures of which are hereby incorporated by reference:
polyurethanes according to EP 0 154 678 A and EP 0 318 999 A;
polyurethanes according to EP 0 270 126 A;
modified polyurethanes and polyamines according to EP 1 593 700 A;
salted polyamines according to EP 0 893 155 A;
phosphoric acid ester according to EP 0 417 490 A;
branched polymers containing imidazole groups according to EP 1 081 169 A;
ethoxylates, in particular alkoxylated epoxide/amine adducts, according to EP 1 650 246 A and epoxide adducts according to EP 1 486 524 A;
copolymers with fatty acid according to EP 1 640 389 A;
esterified polyacrylates according to EP 0 879 860 A;
acid-functional polyester according to WO 2005/097872 A;
block copolymers (gradient copolymers) according to EP 1 416 019 A.

As already explained above, the combination of thickener on the one hand and wetting or dispersing agent on the other hand according to the invention can achieve stabilization of highly filled dispersions of compounds with high residual solubility, wherein in particular long-term stable low-viscosity dispersions can be obtained.

In the context of the present invention, it has been particularly well proven if the composition contains the thickener and the wetting or dispersing agent in defined ratios to one another.

Particularly good results are obtained if the composition comprises a weight-related ratio of thickener to wetting or dispersing agent (thickener:wetting or dispersing agent) in the range from 2:1 to 1:20, in particular 1:1 to 1:15, preferably 1:1 to 1:10, more preferably 1:2 to 1:8, particularly preferred 1:3 to 1:5.

The aqueous composition according to the invention thus preferably comprises a significantly larger amount of wetting or dispersing agent compared to the thickener.

Nevertheless, the presence of a thickener is essential to prevent Ostwald ripening and to obtain dispersions with long-term stability.

As regards the amount in which the composition comprises the thickener, it is well proven if the composition comprises the thickener in amounts of up to 20 wt. %, in particular up to 18 wt. %, preferably up to 15 wt. %, more preferably up to 12 wt. %, based on the composition.

Similarly, it may be envisaged that the composition comprises the thickener in amounts of more than 1 wt. %, in particular more than 2 wt. %, preferably more than 5 wt. %, more preferably more than 8 wt. %, based on the composition.

Furthermore, it has been well proven in the context of the present invention if the composition comprises the thickener in amounts of 1 to 20 wt. %, in particular 2 to 18 wt. %, preferably 5 to 15 wt. %, more preferably 8 to 12 wt. %, based on the composition.

As regards the amount in which the composition contains the wetting or dispersing agent, this can naturally vary over a wide range. However, it is well proven if the composition comprises the wetting or dispersing agent in amounts of up to 65 wt. %, in particular up to 60 wt. %, preferably up to 55 wt. %, more preferably up to 50 wt. %, based on the composition.

Similarly, it may be envisaged in the context of the present invention that the composition comprises the wetting or dispersing agent in amounts of more than 20 wt. %, in particular more than 25 wt. %, preferably more than 30 wt. %, more preferably more than 35 wt. %, based on the composition.

According to a preferred embodiment of the present invention, the composition comprises the wetting or dispersing agent in amounts of 20 to 65 wt. %, in particular 25 to 60 wt. %, preferably 30 to 55 wt. %, more preferably 35 to 50 wt. %, based on the composition.

With thickeners as well as wetting and dispersing agents in the aforementioned amounts, a solution or dispersion can be obtained which is excellently suited as an additive for stabilizing dispersions comprising high amounts of a compound with high residual solubility.

As previously stated, the composition is an aqueous composition. In this context, it is well proven if the composition comprises water in amounts of up to 79 wt. %, in particular up to 78 wt. %, preferably up to 63 wt. %, more preferably up to 57 wt. %, based on the composition.

Similarly, it may be provided that the composition comprises water in amounts of at least 15 wt. %, in particular at least 30 wt. %, preferably at least 38 wt. %, based on the composition.

Furthermore, it may also be envisaged in the context of the present invention that the composition comprises water in amounts of 15 to 79 wt. %, in particular 30 to 78 wt. %, preferably 30 to 63 wt. %, preferably 38 to 57 wt. %, based on the composition.

According to a preferred embodiment of the present invention, the composition comprises
(a) at least one thickener, in particular in amounts of 1 to 20 wt. %,
(b) at least one wetting or dispersing agent, in particular in amounts of 20 to 65 wt. %, and
(c) water, in particular in amounts of 15 to 79 wt. %, in each case based on the composition.

For this particularly preferred embodiment of the present invention, all the aforementioned parameters, features, advantages and special features apply accordingly.

According to another preferred embodiment of the present invention, the composition comprises the aforementioned components (a) to (c).

Further subject-matter of the present invention—according to a second aspect of the present invention—is the use of a previously mentioned aqueous composition for stabilizing an aqueous dispersion which contains at least one compound with a solubility in the range of 0.05 to 10 g/l, in particular 0.05 to 5 g/l, preferably 0.1 to 4 g/l, more preferably 0.2 to 3 g/l, even more preferably 0.2 to 2 g/l, and most preferably 0.3 to 1.5 g/l, in particular preferably 0.4 to 1 g/l, at 20° C. in water.

For further details on the use according to the invention, reference can be made to the above configurations of the aqueous composition according to the invention, which apply accordingly with regard to the use according to the invention.

A further subject-matter of the present invention—according to a third aspect of the present invention—is an aqueous dispersion, in particular a semi-finished product, containing
at least one compound having a solubility in water at 20° C. in the range of 0.05 to 10 g/l,
(ii) at least one thickener and
(iii) at least one wetting or dispersing agent.

The aqueous dispersion according to the invention is obtained in particular by adding a compound having a solubility in water at 20° C. in the range from 0.05 to 10 g/l to the aqueous composition mentioned above or by adding the aqueous composition described above to a dispersion, in particular a suspension, of a compound having a solubility in water at 20° C. in the range from 0.05 to 10 g/l. Alternatively, the thickener and wetting or dispersing agent can also be added separately from each other to an aqueous dispersion of a compound having a solubility in water at 20° C. in the range from 0.05 to 10 g/l, wherein this variant is less preferable according to the invention.

Surprisingly, it is possible within the scope of the present invention to incorporate the aqueous composition mentioned above, comprising at least one thickener and at least one wetting or dispersing agent, into dispersions, in particular suspensions of compounds with a solubility in water at 20° C. in the range from 0.05 to 10 g/l, which are often highly alkaline, with the introduction of low shear forces. The person skilled in the art would expect a strong increase in viscosity and possibly gel formation due to the thickener.

In the context of the present invention, it is advantageously provided that the aqueous dispersion comprises a compound having a solubility of less than 5 g/l, in particular less than 4 g/l, preferably less than 3 g/l, more preferably less than 2 g/l, particularly preferably less than 1.5 g/l, even more preferably less than 1 g/l, at 20° C. in water.

Similarly, it may be envisaged that the aqueous dispersion comprises a compound with a solubility of more than 0.1 g/l, in particular more than 0.2 g/l, preferably more than 0.3 g/l, more preferably more than 0.4 g/l, at 20° C. in water.

In the context of the present invention, it has been well proven if the aqueous dispersion comprises a compound with a solubility in the range 0.05 to 5 g/l, in particular 0.1 to 4 g/l, preferably 0.2 to 3 g/l, more preferably 0.2 to 2 g/l, particularly preferably 0.3 to 1.5 g/l, even more preferably 0.4 to 1 g/l, at 20° C. in water.

In the context of the present invention, it is furthermore usually envisaged that the aqueous dispersion comprises the compound with a solubility in water at 20° C. in the range from 0.05 to 10 g/l, i.e. with a high residual solubility, in amounts of 40 to 80 wt. %, in particular 50 to 75 wt. %, preferably 55 to 70 wt. %, more preferably 60 to 65 wt. %, based on the aqueous dispersion.

The dispersion according to the invention can thus obtain the compound with a solubility in the range from 0.05 to 10 g/l at 20° C. in water in very high amounts without changing or deteriorating the properties of the systems into which the dispersion according to the invention is incorporated or of which it forms the basis, compared to conventional systems.

As previously explained, the compound with a solubility in the range of 0.05 to 10 g/l at 20° C. in water is present in particulate form within the scope of the present invention.

In the context of the present invention, according to one embodiment, it may be provided that the compound with a solubility in the range from 0.05 to 10 g/l at 20° C. in water comprises a particle size distribution D10 in the range from 0.05 to 0.5 μm, in particular 0.1 to 0.4 μm, preferably 0.15 to 0.3 μm, more preferably 0.18 to 0.25 μm.

Similarly, it may be envisaged that the compound with a solubility in the range from 0.05 to 10 g/l at 20° C. in water comprises a particle size distribution D50 in the range from 1.0 to 4 μm, in particular 1.5 to 3.0 μm, preferably 1.8 to 2.7 μm, more preferably 2.0 to 2.5 μm.

It may also be provided that the compound with a solubility in the range from 0.05 to 10 g/l at 20° C. in water comprises a particle size distribution D90 in the range from 5.0 to 10 μm, in particular 5.5 to 8.0 μm, preferably 6.0 to 7.5 μm, more preferably 6.5 to 7.0 μm.

The terms D10, D50 and D90 each mean that 10% of all particles have a smaller particle size or 50% of all particles or 90% of all particles. The particle sizes or the particle size distribution can be determined in particular by laser scattering.

According to this embodiment, it is particularly preferred if the compound with a solubility in the range from 0.05 to 10 g/l at 20° C. in water comprises a particle size distribution D10 of 0.2 μm, a particle size distribution D50 of 2 to 2.5 μm and a particle size distribution D90 of 6.8 μm. With the aforementioned particle size distributions, matt pigment pastes and paints with a high opacity can be obtained, in particular with the use of calcium aluminum sulfate (ettringite).

According to a particularly preferred embodiment of the present invention, the compound with a solubility in the range from 0.05 to 10 g/l at 20° C. in water comprises a particle size distribution D10 in the range from 0.05 to 0.45 μm, in particular 0.1 to 0.4 μm, preferably 0.15 to 0.3 μm, more preferably 0.18 to 0.25 μm.

Similarly, according to this embodiment, it may be provided that the compound with a solubility in the range from 0.05 to 10 g/l at 20° C. in water comprises a particle size distribution D50 in the range from 0.5 to 1.8 μm, in particular 0.6 to 1.5 μm, preferably 0.7 to 1.2 μm, more preferably 0.8 to 1.0 μm.

Furthermore, according to this embodiment, it may be provided that the compound with a solubility in the range from 0.05 to 10 g/l at 20° C. in water comprises a particle size distribution D90 in the range from 2.0 to 4 μm, in particular 2.2 to 3.7 μm, preferably 2.5 to 3.5 μm, more preferably 2.8 to 3.2 μm.

In the context of this preferred embodiment, it is in particular preferred if the compound with a solubility in the range from 0.05 to 10 g/l at 20° C. in water comprises a particle size distribution D10 of 0.2 μm, a particle size distribution D50 of 0.9 μm and a particle size distribution D90 of 3.0 μm. With these smaller particle sizes and narrower particle size distribution compared to the embodiment described above, it is possible, in particular when using calcium aluminate sulfate, to produce brilliant color pastes which can be added to standard pigment pastes in amounts of 15 wt. % or more without noticeably changing the brilliance of the color, the color location or the color intensity. The dispersions according to the invention can also be added to colors, varnishes and glazes, cosmetic and pharmaceutical compositions, liquid semi-finished products and raw materials for industrial processes, detergents and cleaning agents, impregnating and disinfecting agents, wherein long-term stable dispersions can be obtained.

According to a special embodiment of the present invention, the compound having a solubility in the range of 0.05 to 10 g/l at 20° C. in water comprises a bimodal particle size distribution. In particular, the compound having a solubility in the range of 0.05 to 10 g/l at 20° C. in water comprises a bimodal particle size distribution with the particle sizes and particle size distribution according to the different embodiments described above. In this way, for example, the color space, color location, color intensity and brilliance of the composition, in particular of pigment pastes and the resulting coating compositions, can be set and determined in a targeted manner.

Within the scope of the present invention, it is thus possible to stabilize usually highly unstable dispersions of compounds with high residual solubility, especially semi-finished products, so that they can be stored and further processed without any problems. The system according to the invention is particularly suitable for stabilizing calcium aluminate sulfate, especially ettringite, but this principle is also transferable to any other, in particular inorganic, compounds with high residual solubility in aqueous media.

In the context of the present invention, it is usually envisaged that the aqueous dispersion comprises the thickener in amounts of 0.01 to 5 wt. %, in particular 0.05 to 2 wt. %, preferably 0.1 to 1 wt. %, more preferably 0.1 to 0.5 wt. %, based on the dispersion.

Similarly, it may be provided that dispersion comprises the thickener in amounts of at least 0.1 wt. %, in particular at least 0.5 wt. %, more preferably at least 0.1 wt. %, based on the dispersion. In addition, it is equally well proven if the dispersion comprises the thickener in amounts of at most 5 wt. %, in particular at most 2 wt. %, preferably at most 1 wt. %, more preferably at most 0.5 wt. %, based on the dispersion.

Furthermore, it may be envisaged in the context of the present invention that the dispersion comprises the wetting or dispersing agent in amounts of at least 0.1 wt. %, in particular at least 0.2 wt. %, preferably at least 0.3 wt. %, more preferably 0.5 wt. %, based on the dispersion.

Good results are also obtained if the dispersion comprises the wetting or dispersing agent in amounts of at most 8 wt. %, in particular at most 5 wt. %, preferably at most 2 wt. %, more preferably at most 1 wt. %, based on the dispersion.

In the context of the present invention, it has furthermore been well proven if the dispersion comprises the wetting or dispersing agent in amounts of 0.1 to 8 wt. %, in particular 0.2 to 5 wt. %, preferably 0.3 to 2 wt. %, more preferably 0.5 to 1 wt. %, based on the dispersion.

The aqueous dispersion also contains water in significant amounts. In the context of the present invention, it may be envisaged that the aqueous dispersion comprises water in amounts of at least 5 wt. %, in particular at least 15 wt. %, preferably at least 25 wt. %, more preferably at least 35 wt. %, based on the dispersion.

Similarly, it may be provided that the aqueous dispersion comprises water in amounts of at most 60 wt. %, in particular at most 55 wt. %, preferably at most 50 wt. %, more preferably at most 45 wt. %, based on the dispersion.

Particularly good results are obtained in the context of the present invention if the aqueous dispersion comprises water in amounts of 5 to 60 wt. %, in particular 15 to 55 wt. %, preferably 25 to 50 wt. %, more preferably 35 to 45 wt. %, based on the dispersion.

According to a preferred embodiment, the aqueous dispersion thus contains
the compound with a solubility of less than 10 g/l, in particular in amounts of 40 to 80 wt. %,
(ii) at least one thickener, in particular in amounts of 0.1 to 5 wt. %,
(iii) at least one wetting or dispersing agent, in particular in amounts of 0.1 to 8 wt. %, and
(iv) water, in particular in amounts of 5 to 60 wt. %, in each case based on the dispersion.

For this preferred embodiment of the present invention, all parameters, features, advantages and particularities mentioned above in the context of other embodiments apply accordingly.

In the context of the present invention, it is in particular usually provided that the dispersion comprises a pH adjusting agent. In the case of a pH adjusting agent, the pH value is in particular set to particularly preferred ranges both for the stability of the dispersion and to prevent infestation with germs.

The pH adjusting agent is usually selected from inorganic and organic acids and bases, in particular inorganic and organic bases, preferably inorganic bases.

If the dispersion contains a pH adjusting agent, it is well proven if the pH adjusting agent is selected from the group of hydrochloric acid, sulfuric acid, nitric acid, citric acid, pyridinecarboxylic acid, acetic acid, sodium hydroxide, potassium hydroxide, lithium hydroxide, calcium hydroxide, ammonia, water glass, dimethylglucamine and mixtures thereof. Preferably, the pH adjusting agent is selected from the group consisting of sodium hydroxide, potassium hydroxide, lithium hydroxide, calcium hydroxide, ammonia, water glass, dimethylglucamine and mixtures thereof.

If the dispersion contains a pH adjusting agent, the composition usually contains the pH adjusting agent in amounts of 0.01 to 10 wt. %, in particular 0.1 to 8 wt. %, preferably 0.5 to 7 wt. %, more preferably 1 to 5 wt. %, based on the dispersion.

According to another preferred embodiment, the aqueous dispersion thus contains
the compound with a solubility of less than 10 g/l, in particular in amounts of 40 to 80 wt. %,
(ii) at least one thickener, in particular in amounts of 0.1 to 5 wt. %,
(iii) at least one wetting or dispersing agent, in particular in amounts of 0.1 to 8 wt. %,
(iv) water, in particular in amounts of 5 to 60 wt. %,
(v) at least one pH adjusting agent, in particular in amounts of 0.01 to 10 wt. %, in each case based on the dispersion.

For this preferred embodiment of the present invention, all parameters, features, advantages and particularities mentioned above in the context of other embodiments apply accordingly.

Advantageously, the dispersion usually comprises at least one additive. Typically, the additive is selected from the group of rheology additives, stabilizers, defoaming components, pH stabilizers, rheology improvers and mixtures thereof.

Suitable defoaming components are usually small amounts of hydrophobic ingredients, such as vaseline oil (INCI: petrolatum), castor oil, mineral oils, vegetable oils or the silicone compounds known by their INCI names, such as Bisphenylhexamethicone, Dimethicone, Dimethicone Silylate, Dimethiconol, Diphenyl Dimethicone, Diphenylsiloxy Phenyl Trimethicone, Disiloxane, PEG/PPG-12/16 Dimethicone, PEG/PPG-12/18 Dimethicone, PEG/PPG-16/8 Dimethicone, PEG/PPG-8/26 Dimethicone, Phenetyl Disiloxane, Phenyl Dimethicone, Phenyl Trimethicone, Polysilicone-1, Polysilicone-2, Polysilicone-7, Polysilicone-8, Polysilicone-10, Silica Dimethicone Silylate, Silica Silylate, Simethicone, Trimethylsiloxysilicate, Trimethylsiloxysilicate/Dimethicone Crosspolymer, Triphenyl Trimethicone and Trisiloxane, Behenyl Methacrylate/Ethylamine Oxide, Methacrylate Copolymer, C12-14 Sec-Pareth-5, Hexamidine Diisothionate, Hexyldeceth-2, Laureth-5 Butyl Ether, Rhus Semialata Leaf Extract, as well as the combination of hydrophobic components with solids, for example silica, such as Sipernate® grades from Evonik Industries.

Alcohols, such as ethanol, isopropanol, hexan-1-ol, propan-2-ol, can also have a defoaming effect, in particular when used in larger quantities.

If the dispersion comprises an additive, it is well proven if the dispersion contains the additive in amounts of 0.01 to 10 wt. %, in particular 0.1 to 8 wt. %, preferably 0.5 to 6 wt. %, more preferably 1 to 5 wt. %, based on the dispersion.

According to another preferred embodiment, the aqueous dispersion thus contains
the compound with a solubility of less than 10 g/l, in particular in amounts of 40 to 80 wt. %,
(ii) at least one thickener, in particular in amounts of 0.1 to 5 wt. %,
(iii) at least one wetting or dispersing agent, in particular in amounts of 0.1 to 8 wt. %,
(iv) water, in particular in amounts of 5 to 60 wt. %,
(v) at least one pH adjusting agent, in particular in amounts of 0.01 to 10 wt. %, and
(vi) at least one additive in amounts of 0.01 to 10 wt. %, in each case based on the dispersion.

For this preferred embodiment of the present invention, all parameters, features, advantages and particularities mentioned above in the context of other embodiments apply accordingly.

Furthermore, all embodiments of the aqueous dispersion preferably comprise a basic pH value. In this context, it has been specially well proven if the dispersion comprises a pH value of 9.5 or higher. Particularly good results are obtained in this context if the dispersion comprises a pH value in the range from 9.5 to 14, preferably 9.5 to 13, preferably 9.5 to 12, particularly preferably 9.5 to 11.5, even more preferably 10.2 to 11.4.

In the context of the present invention, it is usually envisaged that the dispersion is at least substantially free of preservatives, in particular free of preservatives.

Similarly, in the context of the present invention it is preferably provided that the dispersion is at least substantially free of biocides, in particular free of biocides.

The dispersions according to the invention preferably contain no preservatives, no biocides and are also free of volatile organic compounds, i.e. VOC-free, so that they usually do not contain any substances requiring declaration and can be used in a variety of ways without any problems from the point of view of environmental protection, health protection and occupational safety.

Furthermore, the dispersions according to the invention are storage-stable, in particular over a period of at least 2 months, in particular at least 4 months, in particular at least 6 months, preferably at least 12 months. Similarly, it may be envisaged that the dispersions according to the invention are storage-stable over a period of 2 to 36 months, in particular 4 to 20 months, in particular 6 to 18 months, preferably 12 to 15 months.

The term “storage-stable” means that the physical and chemical properties of the composition do not change during storage or only change to an extent that does not impair the application properties of the composition.

Furthermore, it is well proven if the dispersion comprises a dynamic viscosity according to Brookfield at 25° C. in the range of 50 to 500 mPas, in particular 60 to 300 mPas, preferably 100 to 200 mPas.

For further details of this aspect of the invention, reference can be made to the above configurations of the other aspects of the invention, which apply accordingly with respect to the aqueous dispersion according to the invention.

Again, a further subject-matter of the present invention—according to a fourth aspect of the present invention—is a method for producing an aforementioned aqueous dispersion, wherein a dispersion containing at least one compound having a solubility at 20° C. in water in the range from 0.05 to 10 g/l is provided and an aforementioned aqueous composition is added.

Particularly good results are obtained in the context of the present invention if the addition of the aqueous composition is effected with the introduction of shear forces. The introduction of shear forces can be effected by means of conventional mixing devices, in particular dissolvers.

For further details of the method according to the invention, reference can be made to the above configurations relating to the other aspects of the invention, which apply mutatis mutandis with respect to the method according to the invention.

The subject-matter of the present invention is illustrated below in a non-limiting manner with reference to the embodiment examples.

### Examples

### 1. Calcium Aluminate Sulfate

Calcium aluminate sulphate suspensions form an insoluble sediment after a short time, which cannot be dispersed again. This sediment is initially formed by sedimentation of the calcium aluminate sulphate components and then hardens as part of an Ostwald ripening process.

This settling behaviour can be characterized using LUMiSizer measurements. The LumiSizer is an analytical centrifuge from the manufacturer LUM with an integrated optical sensor to analyse and characterize the particle and droplet velocity for creaming and sedimentation phenomena. Microcuvettes are used for low-viscosity samples. For the evaluation, the cuvette position in the LumiSizer is plotted against the measured light transmission To determine the sedimentation behavior, the sample is subjected to accelerated sedimentation and irradiated using an 865 nm laser at fixed time intervals. The transmission provides information about the sedimentation behavior of the sample. The faster a sample settles in the defined time interval, the more unstable it is. This results in a high value in the instability index.”

FIG. 1 shows the sedimentation profile of a commercially available calcium aluminate sulphate suspension in the LUMiSizer. The calcium aluminate sulphate suspension comprises a specific gravity of 1.40 g/cm³, a solids content of 60 to 64 wt. % and a particle size distribution of d10=approx. 0.2 m, d50=approx. 0.9 m and d90=approx. 3.0 m.

From an increasing transmission at the surface, a deposition of opaque components at the bottom of the cuvette can be concluded—a sediment forms. The light gray to dark gray gradient forms a 3rd dimension as a time axis. Light gray measured values occur early in time, while the dark gray values were recorded at the end of the measurement. The representation of the evaluation can be customized. It is usual to indicate the dispersion stability via an instability index. The instability index is calculated as a dimensionless value by the device software using the sedimentation speed of the dispersion particles, and is always related to a time t. The time t=500 seconds is usually selected for the representation of the instability index.

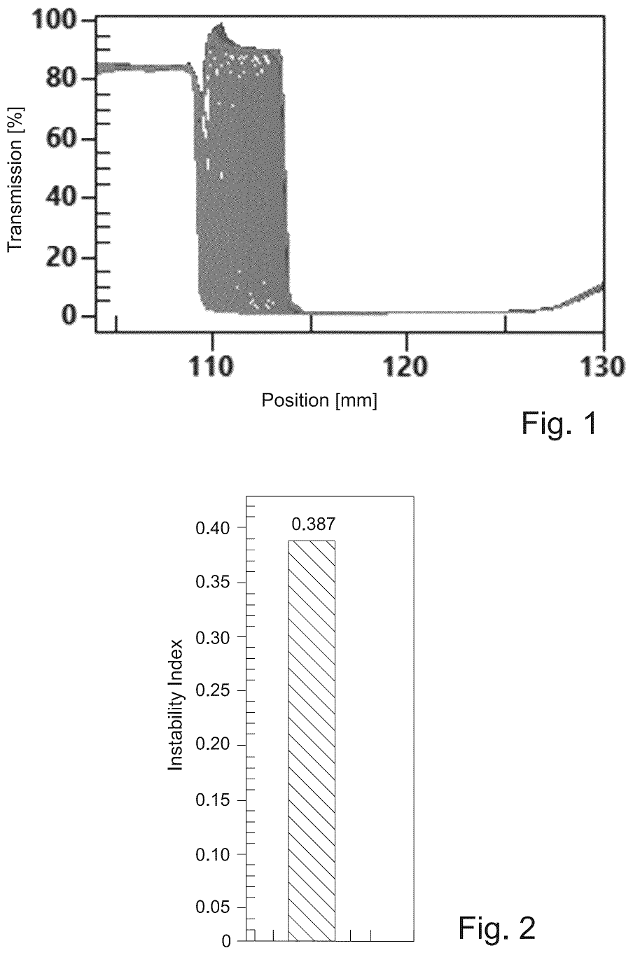

The stability index of the commercially available calcium aluminate sulphate suspension used at time t=500 seconds is 0.387, as shown in FIG. 2, which shows stabilization of the calcium aluminate sulphate suspension, producing a premix composition according to the invention.

To stabilize the stabilization of the calcium aluminate sulfate suspension, aqueous compositions according to the invention containing a wetting or dispersing agent and a thickener were produced.

The preparation of the compositions according to the invention is exemplified by the premix used for producing the dispersion E1 according to the invention given in Table 1: 90 wt. % of an aqueous dispersion of wetting or dispersing agent (a maleic acid styrene copolymer with pigment affinity groups) with a solids content of 40 wt. % were introduced and 10 wt. % of a thickener (water-soluble, non-ionic hydroxyethyl cellulose) were added while stirring. The thickener can be dispersed uniformly and no gelling or thickening of the dispersion is observed, producing the dispersions according to the invention. The producing of the dispersions according to the invention is exemplified by the producing of the dispersion E1 according to the invention.

To produce the dispersion E1 according to the invention, 98 wt. % of the commercially available calcium aluminate sulfate suspension with a solid content of 62 wt. % are introduced and slowly mixed with 2 wt. % of the premix (composition according to the invention) while stirring. The mixture is then stirred in a dissolver for 30 minutes. A low-viscosity dispersion is obtained which can be stored for several months and shows little or no sedimentation.

The further examples E2 to E6 according to the invention were obtained accordingly from premixes, i.e. aqueous dispersions of wetting or dispersing agent and thickener. The exact compositions of the dispersions E1 to E6 according to the invention are given in Table 1.

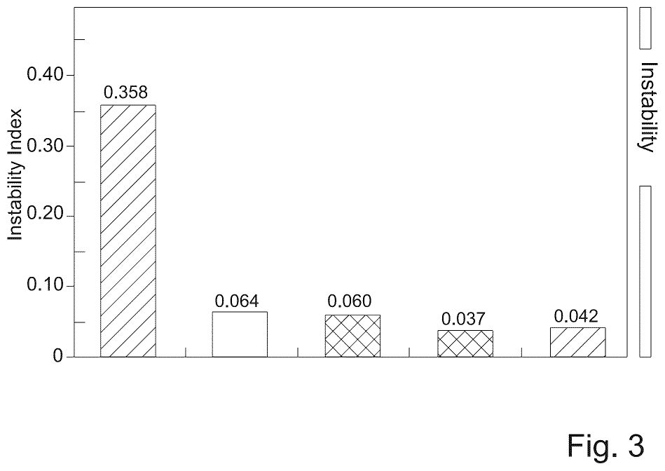

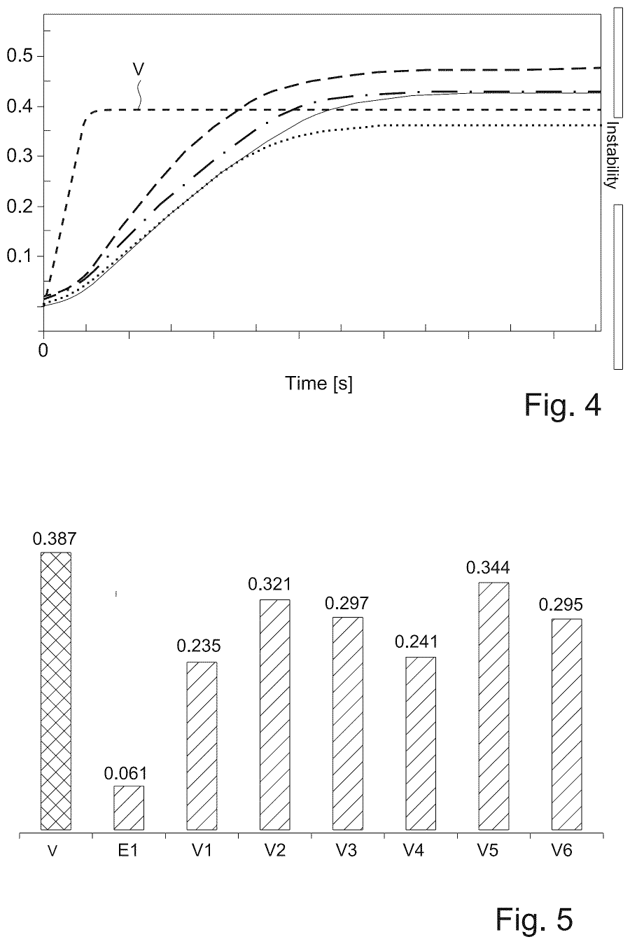

As can be seen in FIGS. 3 and 4, the calcium aluminate sulphate suspension could be stabilized in the form of dispersion E1: The measurements were carried out four times and applied against the commercially available calcium aluminate sulphate suspension as a standard. The standard calcium aluminate sulphate suspension is already completely settled at time t=500 s (stability index 0.358), while the stabilized dispersions settle with a considerable time delay.

The stability index at the time t=500 seconds for the dispersion according to the invention was in the range of 0.037 to 0.064 (see FIG. 3), which corresponds to an improvement by a factor of 15 compared to the commercially available calcium aluminate sulphate suspension.

In fundamental contrast to the non-stabilized, commercially available calcium aluminate sulphate suspension, no non-redispersible sediment forms in the calcium aluminate sulphate suspension stabilized according to the invention. If a sediment forms, it can be redispersed without any problems, since Ostwald ripening is suppressed in the suspensions stabilized according to the invention.

TABLE 1
Composition of the calcium aluminate sulfate suspension used and of the
dispersions E1 to E6 according to the invention in percentages by weight;
when aqueous dispersions are used as starting material, the solids content
in percent by weight is given in brackets in each case

| Raw material | V | E1 | E2 | E3 | E4 | E5 | E6 |
|---|---|---|---|---|---|---|---|
| Calcium aluminate sulphate suspension | 100 | 98 | 98 | 98 | 98 | 98 | 98 |
| (62 wt. %) | | | | | | | |
| Water-soluble, non-ionic hydroxyethyl | | 0.2 | 0.2 | 0.2 | 0.2 | 0.2 | 0.2 |
| cellulose (100 wt. %) | | | | | | | |
| Maleic acid styrene copolymer with | | 1.8 | | | | | |
| pigment affinity groups (40 wt. %) | | | | | | | |
| Anionic copolymer with pigment affinity | | | 1.8 | | | | |
| groups (50 wt. %) | | | | | | | |
| High molecular weight block copolymer | | | | 1.8 | | | |
| (100 wt. %) | | | | | | | |
| Sodium salt of a polycarboxylate | | | | | 1.8 | | |
| (25 wt. %) | | | | | | | |
| Copolymer with pigment affinity groups | | | | | | 1.8 | |
| (40 wt. %) | | | | | | | |
| Sodium salt of a polyacrylic acid | | | | | | | 1.8 |
| (45 wt. %) | | | | | | | |

### Comparative Examples

In order to illustrate the performance of the system according to the invention, the comparative tests V1 to V6 were carried out, in each of which 99 wt. % of a commercially available calcium aluminate sulphate suspension were mixed with one part by weight of a thickener. The exact compositions can be found in Table 2.

The stability index of the dispersions was then determined at time t=500 seconds. The results are shown in FIG. 5. It can be seen that significant stabilization can only be achieved for the dispersion E1 according to the invention. The stability of dispersions V1 to V6 is slightly increased in some cases, but the viscosity increases significantly for all dispersions V1 to V6.

TABLE 2
Composition of the calcium aluminate sulfate suspension used,
the dispersions E1 according to the invention and the comparative
dispersions V1 to V6 in percentages by weight; when aqueous
dispersions are used as starting material, the solids content
is given in brackets in percent by weight in each case:

| Raw material | V | E1 | V1 | V2 | V3 | V4 | V5 | V6 |
|---|---|---|---|---|---|---|---|---|
| Calcium aluminate sulphate | 100 | 98 | 98 | 98 | 98 | | | |
| suspension (62 wt. %) | | | | | | | | |
| Water-soluble, non-ionic | | 0.2 | | | | | | |
| hydroxyethyl cellulose | | | | | | | | |
| (100 wt. %) | | | | | | | | |
| Maleic acid | | 1.8 | 2 | | | | | |
| styrene copolymer | | | | | | | | |
| with pigment affinity groups | | | | | | | | |
| (40 wt. %) | | | | | | | | |
| Hydrophobic fumed | | | | 2 | | | | |
| silicic acid | | | | | | | | |
| (100 wt. %) | | | | | | | | |
| Urethane-containing | | | | | 2 | | | |
| associative | | | | | | | | |
| thickener | | | | | | | | |
| (100 wt. %) | | | | | | | | |
| Layered silicate (smectite) | | | | | | 2 | | |
| (100 wt. %) | | | | | | | | |
| Organically modified | | | | | | | 2 | |
| phyllosilicate (100 wt. %) | | | | | | | | |
| Delaminated phyllosilicate | | | | | | | | 2 |
| (100 wt. %) | | | | | | | | |

### 2. Calcium Silicate Hydrate

For the following tests, a commercially available aqueous suspension of calcium silicate hydrate was used, comprising a calcium silicate hydrate content of 50 wt. % o. The suspension shows rapid sedimentation, in the course of which an insoluble, non-redispersible sediment forms.

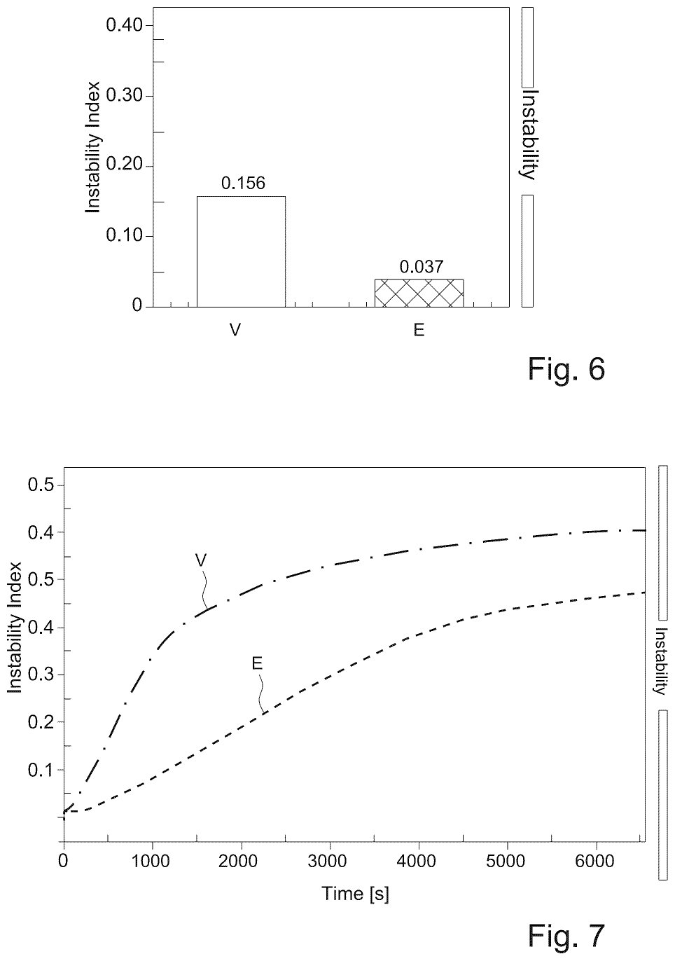

A sample of this suspension (sample V) is examined with the LUMiSizer. The result is represented in FIG. 6 and the stability index after 500 s is 0.156.

Another sample (sample E) of the calcium silicate hydrate suspension was mixed with the premix of wetting or dispersing agent and thickener, which was used for producing the calcium aluminate sulfate sample E1.

To produce the premix, 90 wt. % of an aqueous dispersion of a wetting or dispersing agent (a maleic acid styrene copolymer with pigment affinity groups) with a solids content of 40 wt. % were introduced and 10 wt. % of a thickener (water-soluble, non-ionic hydroxyethyl cellulose) were added while stirring.
2 wt. % of this premix were then mixed with 98 wt. % of the calcium silicate hydrate suspension and the mixture was analyzed with the LUMiSizer (sample E). The result is represented in FIG. 6 and the stability index after 500 s is 0.037. Again, the settling behavior is significantly improved and, in particular, the production of a sediment that cannot be redispersed is effectively prevented; if a sediment forms, it can be easily redispersed.

FIG. 7 shows a comparison of the development of the stability indices of the commercially available calcium silicate hydrate suspension (sample V) and the calcium silicate hydrate suspension stabilized according to the invention (sample E). Here, too, the significantly lower and time-delayed sedimentation of the sample according to the invention is again impressively demonstrated.

1. Aqueous composition, in particular solution or dispersion, for stabilizing dispersions which comprise a compound having a solubility in water in the range from 0.05 to 10 g/ll at 20° C., wherein aqueous composition comprises at least one thickener and at least one wetting or dispersing agent.

2. The aqueous composition according to claim 1, wherein the dispersion to be stabilized comprises a compound having a solubility in water in the range from 0.05 to 5 g/l at 20° C.

3. The aqueous composition according to claim 1, wherein the thickener is selected from the group of polysaccharides, proteins, polyvinyl alcohols, silicic acids, silicates and mixtures thereof.

4. The aqueous composition according to claim 1, wherein the thickener is selected from the group consisting of xanthan gum, beta-glucans, thiolized polysaccharides, proteoglycans, gum arabic, karaya, tragacanth, locust bean gum, guar, quince glue, pectin, agar-agar, carrageenan, alginates, starches, starch derivatives, cellulose, cellulose derivatives, in particular cellulose ethers, silicic acids, bentonites, phyllosilicates, polyvinyl alcohols, gelatine, casein and mixtures thereof.

5. The aqueous composition according to claim 4, wherein the thickener is selected from the group consisting of xanthan gum, beta-glucans, thiolized polysaccharides, proteoglycans, cellulose ethers, silicic acids, bentonites, layered silicates, polyvinyl alcohols, gelatin, casein and mixtures thereof.

6. The aqueous composition according to claim 4, wherein the thickener is a cellulose ether.

7. The aqueous composition according to claim 1, wherein the wetting or dispersing agent is selected from the group of polymers with pigment-affinitive groups, silicone-modified polymers, block copolymers, graft copolymers, surfactants, modified natural oils and mixtures thereof.

8. The aqueous composition according to claim 1, wherein the wetting or dispersing agent is selected from the group of polycarboxylates polyphosphates, polyether phosphates, polycarboxylic acid polymers, acrylic block copolymers, polyurethanes, ethoxylated fatty alcohols, nonionic saturated long-chain alcohols, fatty alcohol sulfates, alkyl phosphonates, polysiloxane ethers, alkyl diol ethoxylates, surfactants, gemini surfactants, bola surfactants, fluorosurfactants, modified natural oils and mixtures thereof.

9. The aqueous composition according to claim 8, wherein the wetting or dispersing agent is selected from the group of salts of polyacrylic acids, polyphosphates, polyether phosphates, polycarboxylic acid polymers, acrylic block copolymers, polyurethanes, ethoxylated fatty alcohols, nonionic saturated long-chain alcohols, fatty alcohol sulfates, alkyl phosphonates, polysiloxane ethers, alkyl diol ethoxylates, gemini surfactants, bola surfactants, modified natural oils and mixtures thereof.

10. The aqueous composition according to claim 9, wherein the wetting or dispersing agent is selected from the group of sodium salts of polyacrylic acids, ammonium salts of polyacrylic acids, polyether phosphates, polycarboxylic acid polymers, modified styrene-maleic acid copolymers, polysiloxane ethers, gemini surfactants, bola surfactants, modified natural oils and mixtures thereof.

11. The aqueous composition according to claim 1, wherein the composition has a ratio by weight of thickener to wetting or dispersing agent (thickener:wetting or dispersing agent) in the range from 2:1 to 1:20.

12. The aqueous composition according to claim 1, wherein the composition comprises the thickener in amounts of 1 to 20 wt. % based on the composition.

13. The aqueous composition according to claim 1, wherein the composition comprises the wetting or dispersing agent in amounts of 20 to 65 wt. % based on the composition.

14. The aqueous composition according to claim 1, wherein the composition comprises water in amounts of 15 to 79 wt. %, based on the composition.

15. Use of the aqueous composition according to claim 1 for stabilizing an aqueous dispersion which comprises at least one compound having a solubility in water in the range from 0.05 to 10 g/l, at 20° C.

16. An aqueous dispersion comprising:
at least one compound having a solubility in water at 20° C. in the range from 0.05 to 5 g/l;
at least one thickener; and
at least one wetting or dispersing agent.

17. A method for producing an aqueous dispersion comprising at least one compound having a solubility in water at 20° C. in the range from 0.05 to 5 g/l, at least one thickener, and at least one wetting or dispersing agent, the method comprising providing at least one compound with a solubility in water in the range from 0.05 to 10 g/l at 20° C. and adding the aqueous composition according to claim 1.
